(19) United States
(12) Patent Application Publication
(10) Pub. No.: US 2008/0077950 A1
(43) Pub. Date: Mar. 27, 2008

(54) System and method for billing for video content

(75) Inventors: Richard Burke, Dublin, CA (US); Canhui Ou, Danville, CA (US); Raghvendra Savoor, Walnut Creek, CA (US); Stephen A. Sposato, Lafayette, CA (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/510,857

(22) Filed: Aug. 25, 2006

(51) Int. Cl. H04N 7/16

(52) U.S. Cl. 725/1

(57) ABSTRACT

Methods and systems of billing for video content are disclosed. The methods include determining a viewing duration. The viewing duration includes an amount of time that a device displays or has access to display video content. The method also includes determining a billing rate for the viewing duration. The billing rate includes a cost per unit of time. The method also includes generating a billing record including the viewing duration and the billing rate.

### FIELD OF THE DISCLOSURE

The present disclosure is generally related to video content distribution and billing.

### BACKGROUND

Consumers who pay for access to television, movies, sporting events or other video content typically pay for time and/or channels that they do not use. For example, in a traditional cable television subscription the consumer pays a subscription fee for access to a number of channels of video content during a subscription period. If the consumer does not watch every channel every minute of the subscription period, the consumer is paying for time and/or channels he or she does not actually use. In another example, video on demand systems typically charge the consumer a set price for access to video content. Thus, a video on demand movie costs a predetermined amount whether or not the consumer watches the entire movie. In yet another example, some have proposed an “a la carte” subscription where consumers select which channels they desire to have available to them and only pay for those channels. However, even in a la carte subscriptions, the consumer pays for the selected channels to be available whether or not the consumer is watching the channels.

### BRIEF DESCRIPTION OF THE DRAWINGS

FIG. 1 is a diagram of an embodiment of a system for video content distribution and billing;

FIG. 2 is a block diagram of an embodiment of a system for billing for video content;

FIG. 3 is a flow chart of an embodiment of a method of billing for video content;

FIG. 4 is a flow chart of an embodiment of a method of billing for video content; and

FIG. 5 is a block diagram of an embodiment of a general computer system.

### DETAILED DESCRIPTION OF THE DRAWINGS

The present disclosure relates generally to methods, systems and computer readable media for billing. More particularly, the disclosure relates to methods, systems and computer readable media for billing for access to video content.

In a particular embodiment, a method of billing for video content includes determining a first viewing duration. The first viewing duration includes a first amount of time that a device displays or has access to display first video content. The method also includes determining a first billing rate for the first viewing duration. The first billing rate includes a first cost per unit of time. The method also includes generating a first billing record including the first viewing duration and the first billing rate. The method may also include determining a second viewing duration. The second viewing duration may include a second amount of time that the device displays or has access to display second video content. The method may further include determining a second billing rate for the second viewing duration. The second billing rate may include a second cost per unit of time. The method may also include generating a second billing record including the second viewing duration and the second billing rate. The method may include providing a bill based at least in part on the first billing record and the second billing record.

In another particular embodiment, a system for billing for video content includes a timing module to determine a viewing duration. The viewing duration includes an amount of time that a video device has access to video content. The system also includes a pricing module to determine a billing rate associated with the viewing duration. The billing rate includes a cost per unit of time. The system further includes a recordkeeping module to generate a billing record based at least in part on the viewing duration and the associated billing rate.

Yet another particular embodiment includes a computer readable medium tangibly embodying a program of instructions to manipulate a computing system. The computer readable medium may cause the computing system to determine a first viewing duration, determine a first billing rate for the first viewing duration, and generate a first billing record of the first viewing duration and the first billing rate.

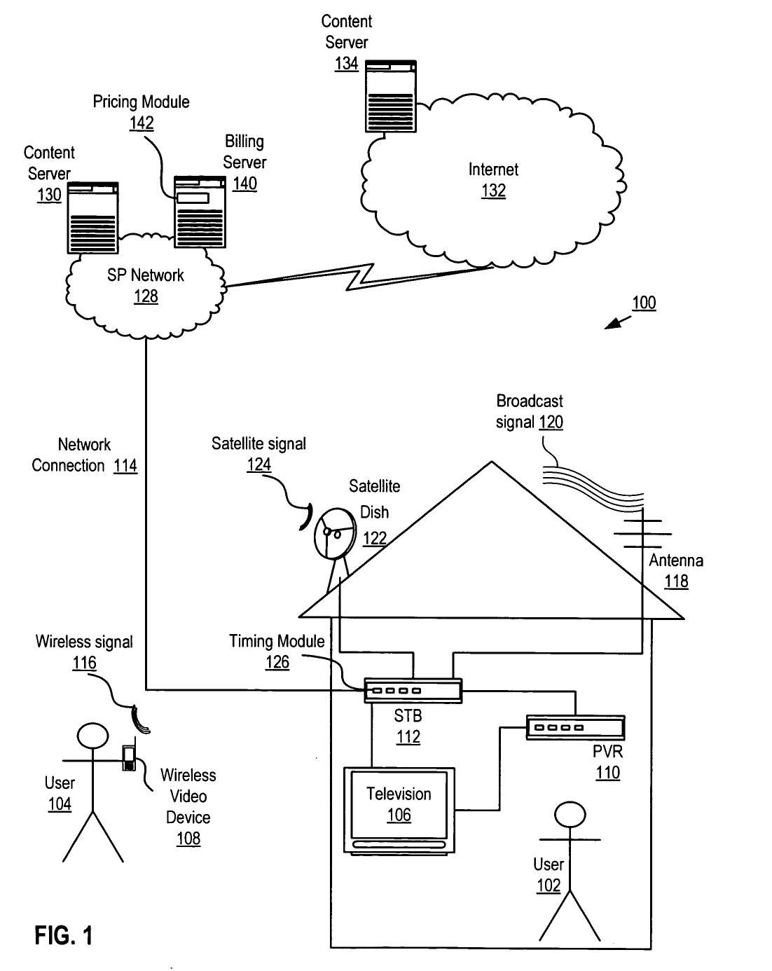

FIG. 1 depicts a simplified illustrative embodiment of a video content distribution and billing system 100. The system 100 is configured to allow distribution of video content, which may also include an audio component, to a plurality of users, for example, user 102 and user 104, from one or more video content servers 130 and 134.

The system 100 includes one or more video devices that may be used to access video content. Each of the users 102, 104 may access video content via one or more of the video devices. The user 104, for example, may access video content via a portable video device, such as wireless video device 108. The wireless video device 108 may include any device capable of receiving video content from a wireless signal 116. Examples of wireless video devices include, but are not limited to, video enabled wireless telephones, personal digital assistants (PDAs), portable computers, portable televisions, etc.

The user 102 may access video content via television 106, personal video recorder (PVR) 110, or other video device. In the particular illustrative embodiment depicted, the television 106 or PVR 110 may receive video content from a set-top box (STB) 112.

The STB 112 may be configured to receive video content from one or more of a variety of video content signal sources. For example, the STB 112 may be coupled to an antenna 118. The antenna 118 may act as a video content signal source by receiving a broadcast signal 120 that includes video content. The STB 112 may be coupled to a satellite dish antenna 122. The satellite dish antenna 122 may act as a video content signal source by receiving a satellite transmission signal 124 that includes video content. The STB 112 may be coupled to a network connection 114. The network connection 114 may act as a video content signal source by communicating a video content signal from a service provider network 128. The system 100 may also include, without limitation: other video content signal sources, other combinations of video content signal sources, and/or other video devices.

Video content may be stored on and/or served from one or more content servers, such as the content server 130 on the service provider network 128, or the content server 134 on the internet 132, or other remote network. The content server 130 or 134 may send requested video content to video devices using a variety of media, transmission equipment, and infrastructure, which are not shown in FIG. 1 to simplify the figure.

The system 100 also includes a billing server 140. The billing server 140 may, for example, include a timing module. In a particular illustrative embodiment, the timing module 126 may be included in STB 112 instead of, or in addition to within the billing server 140. The timing module 126 may determine a viewing duration, such as an amount of time that a video device has access to video content. For example, a viewing duration may include an amount of time that video content is displayed on the television 106, or the amount of time that video content is recorded by the PVR 110. The billing server 140 may also include a pricing module 142 to determine a billing rate associated with the viewing duration. The billing rate may include a cost per unit of time for the video content. The billing server 140 may also include a recordkeeping module to generate billing records based at least in part on the viewing duration and the associated billing rate.

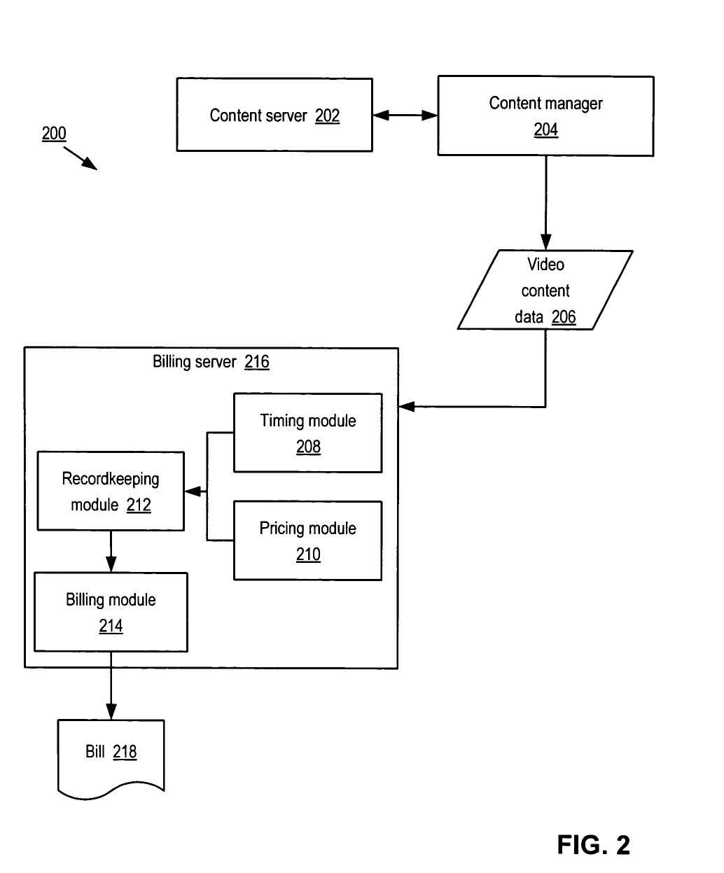

FIG. 2 depicts a particular illustrative embodiment of a billing system 200. The system 200 includes a content server 202 and a content manager 204. The content manager 204 may, for example, be included in the service provider network, may be integrated within a device, such as a STB or video device, or may be a stand alone device. The content manager 204 tracks the user's access to video content from the content server 202. For example, when the user accesses video content from the content server 202, the content server may send video content data 206 to the content manager 204. In another example, when the user accesses video content from the content server 202, the content manager 204 may monitor the access and record the video content data 206.

The video content data 206 may include information sufficient to allow a billing server 216 to generate a billing record for the user's access to the video content. For example, in a particular illustrative embodiment, the video content data 206 may include information about the viewing duration and program category of the video content. The video content data 206 may also include a variety of other information, such as, for example, information that may be used to determine a billing rate for the video content. Additionally, the video content data 206 may include information about the user accessing the video content, such as a user identification of the user.

The billing server 216 includes a timing module 208, a pricing module 210, a recordkeeping module 212, and a billing module 214. The timing module 208 may be configured to determine a viewing duration for video content. For example, the viewing duration may include an amount of time that video content is displayed on or accessed by a video device. The timing module 208 may determine the viewing duration based on information gathered from the content server 202, the content manager 204, or another device, such as set-top box 112 or wireless video device 108, depicted in FIG. 1.

The pricing module 210 may be configured to determine a billing rate for the video content. The billing rate may include a cost per unit of time for the video content. The billing rate may depend on one or more billing factors, such as, but not limited to: the time of day that the video content is accessed, an image format of the video content, the type of video device that accessed the video content, how the video device accesses the video content, whether the video content includes advertisements, whether the user avoided advertisements included in the video content, whether more than one video device accesses the video content, a programming category of the video content, the portion of a program that the video content includes, total viewing time during a billing period, the identity of the user or users that accesses the video content, and so forth.

The recordkeeping module 212 may generate billing records based at least in part on the viewing durations and the associated billing rates from the timing module 208 and pricing module 210, respectively. The billing records may also include information about the user or users that accesses the video content.

The billing module 214 may generate one or more bills 218 based at least in part on the billing records. For example, at the end of a billing period, the billing module 214 may accumulate all of the billing records for the billing period, calculate a total cost for each billing record, and generate a paper or electronic bill 218 for the user or users identified in the billing records. The bill 218 may also include a flat fee and/or other charges in addition to fees based on billing records.

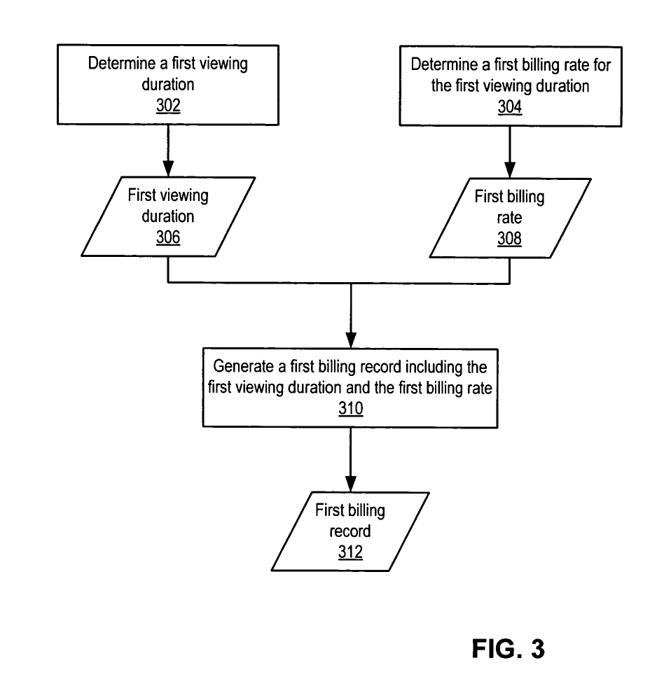

FIG. 3 depicts a particular illustrative embodiment of a method of billing for video content. The method includes determining 302 a first viewing duration 306. The first viewing duration 306 includes a first amount of time that a device displays or has access to display first video content. For example, the first viewing duration 306 may include an amount of time that a television is tuned to receive the video content, an amount of time that a PVR records or subsequently displays the video content, an amount time that a portable video display device receives or displays the video content, etc.

The method also includes determining 304 a first billing rate 308 for the first viewing duration. The first billing rate 308 includes a first cost per unit of time for the first video content. The first billing rate 308 may be based on one or more billing factor such as, but not limited to: time of day of the first viewing duration, image format of the first video content, the type of device that accesses the first video content, how the device access the first video content, whether advertisements are included in the first video content, whether advertisements included in the first video content are avoided by a viewer of the first video content, whether more than one device associated with an account access the first video content, a programming category of the first video content, a portion or segment of a program that is accessed, or a total time of viewing durations during a billing period. These billing factors are further described as follows:

Time of day of the first viewing duration. For example, viewing durations during high demand time periods, such as “prime time,” may have a different billing rate than viewing durations during low demand time periods, such as very early morning hours.

Image format of the first video content. For example, high definition video content may have a different billing rate than standard definition video content. In another example, video content formatted for viewing on a portable or wireless video display device may have a different billing rate than video formatted for display on a television or wired video display device. In yet another example, the billing rate for various display aspect ratios may be different. Thus, video content with a “wide screen” aspect ratio, or a non-standard aspect ratio may have a different billing rate than video content with a standard 4:3 aspect ratio.

Type of device that accesses the first video content. For example, different billing rates may apply depending on whether the video content is accessed by a television, a PVR, or a portable or wireless display device.

How the device accesses the first video content. For example, accessing video content through a wired connection to a content server via a network may have a different billing rate than accessing the video content through a wireless connection. Additionally, different types of wireless or wired connections may have different billing rates. Thus, different billing rates may apply to accessing video content by receiving a broadcast signal, by receiving a satellite signal or by receiving another type of wireless signal. Different billing rates may also apply to accessing video content through a cable network, an IPTV network, or another wired network.

Whether advertisements are included in the first video content. For example, the user may be given the option of accessing video content with advertisements or without advertisements. Different billing rates may apply depending on whether the user elects to watch content with advertisements or without advertisements.

Whether advertisements included in the first video content are avoided by a viewer of the first video content. For example, a different billing rate may apply if a user skips commercials using a PVR or other time-shifting technology, or if the user simply changes the channel or turns off the view device during commercials, than if the user views the commercials.

Whether the first video content is accessed more than once. For example, if two televisions, or a television and a PVR associated with a user's account access the same video content at the same time, a different billing rate may apply than if only a single device, such as a single television, accesses the video content. In another example, a first billing rate may apply for access to the video content by a first device and an additional amount may apply for each additional device that accesses the video content at the same time. In still another example, a first billing rate may apply for an initial access to the video content, and a different billing rate may apply for subsequent access to the video content within a time period.

Programming category of the first video content. For example, different types of video content may be billed at different billing rates. Examples of different kinds of video content may include, but are not limited to: sports programming, special event programming, children's programming, educational programming, etc. In a particular illustrative embodiment, the programming category associated with the video content may be determined at least in part based on market demand for the video content. For example video content of a very popular program may have a different billing rate than video content of a less popular program.

The portion or segment of a program that is accessed. For example, a first portion of a program may be billed at a different billing rate than the last portion of a program. In a particular illustrative embodiment, the first period of a sports event, for example the Super Bowl, may be billed at a different rate than the last period of the sports event. In another illustrative embodiment, a period of time at the beginning of a movie may be billed at a preview billing rate and the remaining portion of the movie may be billed at a different billing rate. In still another illustrative embodiment, the billing rate for a program may change continuously or regularly as the program proceeds.

Total time of viewing durations during a billing period. For example, a customer who accesses 100 hours of video content during a billing period may be billed at different rates for one or more viewing periods than a customer who access only 10 hours of video content during the billing period.

In a particular exemplary embodiment, the billing rate determined may be independent of the bandwidth used during the first viewing duration. In such an embodiment, the billing rate is not a function of how much bandwidth is required to access the video content.

The method also includes generating a first billing record 312 including the first viewing duration 306 and the first billing rate 308. In a particular illustrative embodiment, a plurality of users may be associated with an account. In such an embodiment, the first billing record 312 may also include an identity of at least one user accessing the first video content.

The method depicted in FIG. 3 may be repeated during a billing period for each viewing duration. That is, the method may include determining a second viewing duration. The second viewing duration may include a second amount of time that the same device or another device displays or has access to display second video content. A second billing rate may be determined for the second viewing duration. The second billing rate may include a second cost per unit of time. A second billing record including the second viewing duration and the second billing rate may be generated. In such an embodiment, a bill may be generated and provided (e.g., to a party responsible for the account) based at least in part on the first billing record, the second billing record, and so forth through however many viewing durations make up the billing period.

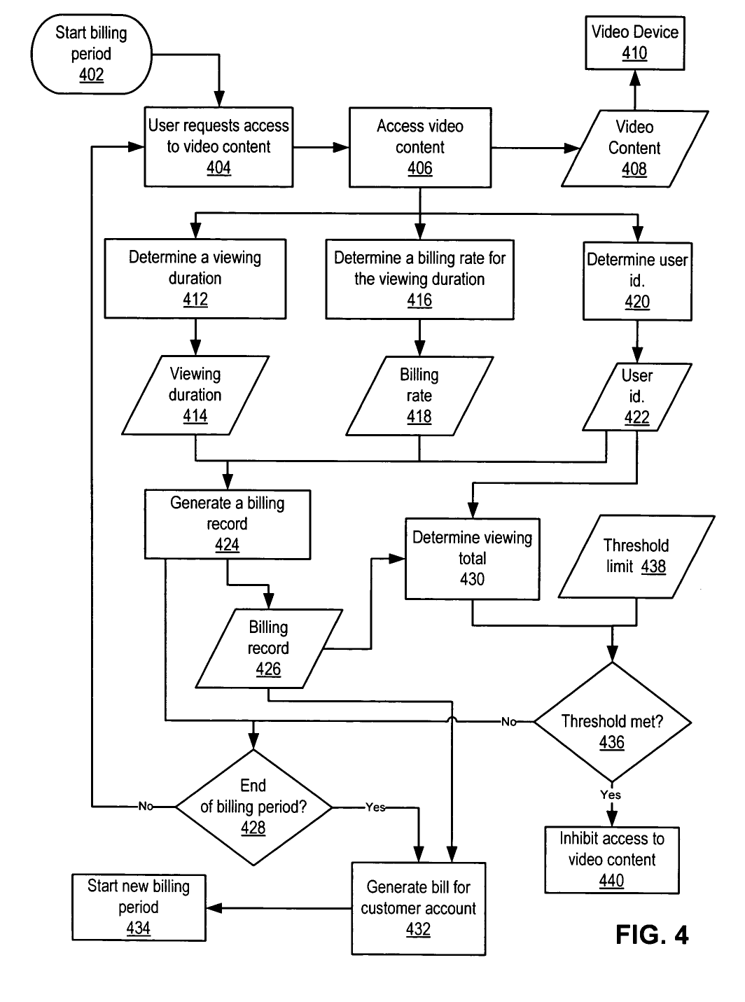

FIG. 4 depicts a particular illustrative embodiment of a method of billing for video content. The method depicted in FIG. 4 begins with the start of a billing period 402. At some point during the billing period, a user may request access to video content 404. The method includes accessing 406 the video content 408 and providing the video content 408 to a video device 410.

In a particular illustrative embodiment, the request to access video content 404 may include user identification credentials, such as, for example, a user identification and password combination, biometric data, etc. In such an embodiment, accessing video content may include determining whether the user is authorized to access the requested video content based on predefined user restrictions. The predefined user restrictions may, for example, restrict certain users from viewing video content based on factors such as, but not limited to: the time of day, an image format of the video content, a type of device accessing the video content, how the device accesses the video content, a programming category of the video content, a content rating of the video content (such as “R” or “TV-14”), identified content of the video content (such as “Adult Situations” or “Violence”) or a user threshold limit on viewing time or cost during a period.

A viewing duration 414 is determined 412 based on how long the user accesses video content. A billing rate 418 for the viewing duration is also determined 416, and a billing record 426 is generated 424. The billing record 426 may include, for example, the viewing duration 414 and billing rate 418. In a particular illustrative embodiment, the billing rate 418, viewing duration 414, and/or a running total of the cost of a particular viewing duration may be displayed to the user at the user's request.

The method also includes determining 428 when the end of the billing period occurs. If the end of the billing period has not occurred, the method may include the user again requesting 404 access to video content. The video content the user requests access to may be the same video content or different video content.

If the end of the billing period has occurred, the method may include generating 432 a bill for the user's account, and starting 434 a new billing period.

In a particular illustrative embodiment, a plurality of users may be associated with an account. In such an embodiment, the method may include determining 420 the identity 422 of the user accessing the video content. The user identity 422 may be determined 420 based on provided user credentials. A billing record 426 generated 424 in such an embodiment may include the user identification 422.

In embodiments where the user identification 422 is determined 420, the method may also include determining 430 a viewing total for an account, or one or more users associated with the account based at least in part on billing records. The viewing total may include for example a total cost or total viewing time based on billing records of access to video content during a billing period or other duration. The viewing total may be compared 436 to a predefined threshold limit 438. The threshold limit 438 may include, for example, a maximum total viewing time, a maximum total cost, a maximum total viewing time for one or more users or a maximum total cost for one or more user. The threshold limit 438 may additionally or alternatively include limitations on specific types of access to video content. For example, the threshold limit 438 may include limitations on one or more of the billing factors previously discussed or other factors. For instance, the threshold limit 438 may include a limitation on one or more users' access to non-educational video content. The method may also include inhibiting 440 access to video content if the viewing total is equal to or greater than the threshold limit 438. In a particular illustrative embodiment, the method may include alerting the user that the threshold limit 438 is approaching or has been reached.

In a particular illustrative embodiment, a threshold limit 438 may be set based on pre-payment of an amount of money. For example, a party responsible for an account may pre-pay a specific amount of money for access to video content, the amount paid for access to video content may establish the threshold limit 438 for the entire account, or for one or more users associated with the account. In another example, a specific amount of money may be paid to purchase a token, such as a gift card, that may be used to establish the threshold limit 438 or make payment for an account. In such an example, a gift card may be purchased that allows the recipient of the gift card access to video content up to a particular dollar amount, up to a particular time limit, to one or more specified programs, to one or more specified types of programs, or some other combination of the billing factors discussed above or other factors.

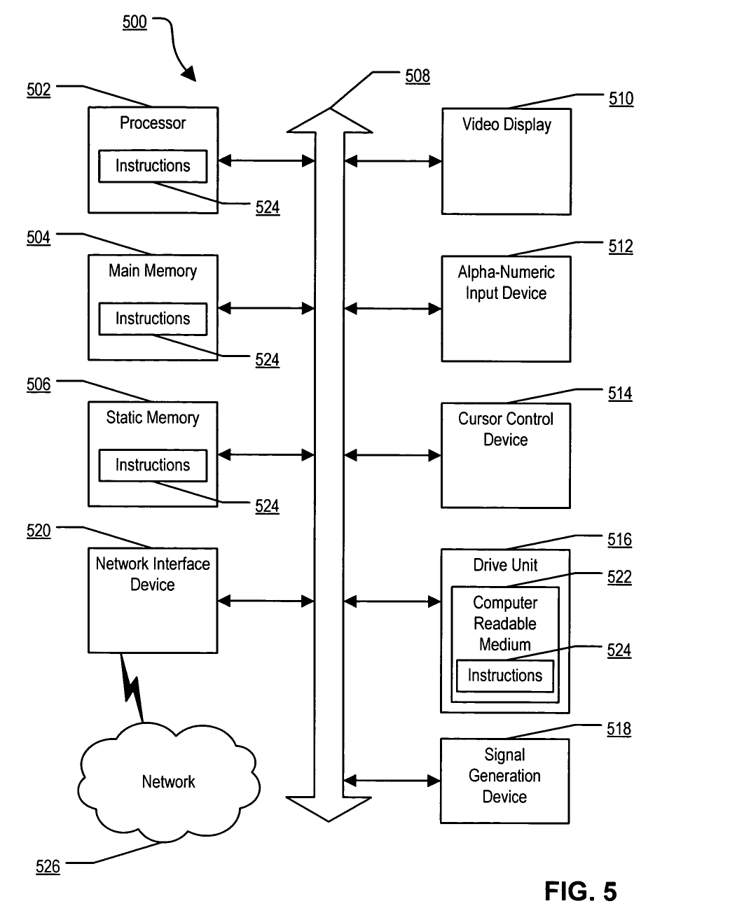

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506, that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of billing for video content, the method comprising:
determining a first viewing duration, wherein the first viewing duration includes a first amount of time that a device displays or has access to display first video content;
determining a first billing rate for the first viewing duration, wherein the first billing rate includes a first cost per unit of time; and
generating a first billing record including the first viewing duration and the first billing rate.

2. The method of claim 1, further comprising:
determining a second viewing duration, wherein the second viewing duration includes a second amount of time that the device displays or has access to display second video content;
determining a second billing rate for the second viewing duration, wherein the second billing rate includes a second cost per unit of time; and
generating a second billing record including the second viewing duration and the second billing rate.

3. The method of claim 2, further comprising providing a bill based at least in part on the first billing record and the second billing record.

4. The method of claim 1, wherein the first billing rate is determined based at least in part on a time of day of the first viewing duration.

5. The method of claim 1, wherein the first billing rate is determined based at least in part on an image format of the first video content.

6. The method of claim 1, wherein the first billing rate is determined based at least in part on a type of device that accesses the first video content.

7. The method of claim 1, wherein the first billing rate is determined based at least in part on how the device accesses the first video content.

8. The method of claim 1, wherein the first billing rate is determined based at least in part on whether advertisements are included in the first video content.

9. The method of claim 1, wherein the first billing rate is determined based at least in part on whether advertisements included in the first video content are avoided by a viewer of the first video content.

10. The method of claim 1, wherein the first billing rate is determined based at least in part on whether the first video content is accessed more than once.

11. The method of claim 1, wherein the first billing rate is determined based at least in part on a programming category of the first video content.

12. The method of claim 11, wherein the programming category associated with the first video content is determined at least in part based on market demand for the first video content.

13. The method of claim 1, wherein the first viewing duration includes a portion of a program and wherein the first billing rate is determined in dependence upon which portion of the program is included in the first viewing duration.

14. The method of claim 1, wherein a plurality of users are associated with an account, and wherein the first billing record further includes an identity of at least one user accessing the first video content.

15. The method of claim 14, further comprising determining a total viewing time for at least one user based at least in part on the first billing record; comparing the total viewing time to a predefined maximum total viewing time for the at least one user; and inhibiting access to additional video content if the total viewing time is equal to or greater than the maximum total viewing time.

16. The method of claim 14, further comprising determining a total cost for at least one user based at least in part on the first billing record; comparing the total cost to a predefined maximum total cost for the at least one user; and inhibiting access to additional video content if the total cost is equal to or greater than the maximum total cost.

17. The method of claim 1, wherein the first billing rate is determined independent of the bandwidth used during the first viewing duration,

18. A system for billing for video content, the system comprising:
a timing module to determine a viewing duration, wherein the viewing duration includes an amount of time that a video device has access to video content;
a pricing module to determine a billing rate associated with the viewing duration, wherein the billing rate includes a cost per unit of time; and
a recordkeeping module to generate a billing record based at least in part on the viewing duration and the associated billing rate.

19. The system of claim 18, further comprising a billing module to determine a total billing amount for a billing period based at least in part on a plurality of viewing durations during the billing period and the billing rate associated with each of the plurality of viewing durations.

20. The system of claim 18, further comprising a content server to serve video content to the video device.

21. A computer readable medium tangibly embodying a program of instructions to manipulate a computing system to:
determine a first viewing duration, wherein the first viewing duration includes a first amount of time that a device displays or has access to display first video content;
determine a first billing rate for the first viewing duration, wherein the first billing rate includes a cost per unit of time for the first video content; and
generate a first billing record of the first viewing duration and the first billing rate.
